(19) United States
(12) Patent Application Publication
(10) Pub. No.: US 2025/0240541 A1
(43) Pub. Date: Jul. 24, 2025

(54) FOCUS PIXEL AIDED CHROMATIC ABERRATION CORRECTION

(71) Applicant: QUALCOMM Incorporated, San Diego, CA (US)

(72) Inventor: Balakrishna MANDADI, San Diego, CA (US)

(21) Appl. No.: 18/421,798

(22) Filed: Jan. 24, 2024

(51) Int. Cl. H04N 25/704; H04N 25/611

(52) U.S. Cl. CPC H04N 25/704; H04N 25/611

(57) ABSTRACT

Systems and techniques are described herein for image correction. For instance, a process can include obtaining image information from an image sensor including an array of pixels, the array of pixels including focus pixels; obtaining phase detection (PD) pixel information from the focus pixels of the image sensor; generating a reference focus map based on PD pixel information for a first color channel; generating a first focus map based on PD pixel information for a second color channel; aligning the first focus map to the reference focus map to detect a misalignment between the reference focus map and the first focus map; determining a magnitude of the misalignment; and applying chromatic aberration correction to the image information based on the detected misalignment and the magnitude of the misalignment.

### FIELD

The present application is generally related to processing images. For example, aspects of the application relate to a focus pixel aided chromatic aberration correction.

### BACKGROUND

A camera is a device that captures images, such as still images or video frames, by receiving light through a lens and by using the lens (and sometimes one or more mirrors) to bend and focus the light onto an image sensor or a photosensitive material such as photographic film. The resulting images are captured by the image sensor and either stored on the photographic film, which can be developed into printed photographs, or stored digitally onto a secure digital (SD) card or other storage device.

Many devices and systems allow a scene to be captured by generating images (or frames) and/or video data (including multiple frames). For example, a camera or a device including a camera (or cameras) can capture a sequence of frames of a scene (e.g., a video of a scene) based on light entering the camera. To enhance a quality of frames captured by the camera, the camera may include lenses to focus light entering the camera. Focus pixels may be used to detect whether the camera is focused properly and if not, how to adjust the focus.

### BRIEF SUMMARY

In some examples, systems and techniques are described for improved imaging processing (e.g., image correction), such as for correcting aberrations in captured images. For example, an apparatus for image correction is provided. The apparatus includes at least one memory and at least one processor coupled to the at least one memory. The at least one is processor configured to: obtain image information from an image sensor including an array of pixels, the array of pixels including focus pixels; obtain phase detection (PD) pixel information from the focus pixels of the image sensor; generate a reference focus map based on PD pixel information for a first color channel; generate a first focus map based on PD pixel information for a second color channel; align the first focus map to the reference focus map to detect a misalignment between the reference focus map and the first focus map; determine a magnitude of the misalignment; and apply chromatic aberration correction to the image information based on the detected misalignment and the magnitude of the misalignment.

In another example, a method for image correction is provided. The method includes: obtaining image information from an image sensor including an array of pixels, the array of pixels including focus pixels; obtaining phase detection (PD) pixel information from the focus pixels of the image sensor; generating a reference focus map based on PD pixel information for a first color channel; generating a first focus map based on PD pixel information for a second color channel; aligning the first focus map to the reference focus map to detect a misalignment between the reference focus map and the first focus map; determining a magnitude of the misalignment; and applying chromatic aberration correction to the image information based on the detected misalignment and the magnitude of the misalignment.

As another example, a non-transitory computer-readable medium having stored thereon instructions is provided. The instructions, when executed by at least one processor, cause the at least one processor to: obtain image information from an image sensor including an array of pixels, the array of pixels including focus pixels; obtain phase detection (PD) pixel information from the focus pixels of the image sensor; generate a reference focus map based on PD pixel information for a first color channel; generate a first focus map based on PD pixel information for a second color channel; align the first focus map to the reference focus map to detect a misalignment between the reference focus map and the first focus map; determine a magnitude of the misalignment; and apply chromatic aberration correction to the image information based on the detected misalignment and the magnitude of the misalignment.

In another example, an apparatus for image correction is provided. The apparatus includes means for obtaining image information from an image sensor including an array of pixels, the array of pixels including focus pixels; means for obtaining phase detection (PD) pixel information from the focus pixels of the image sensor; means for generating a reference focus map based on PD pixel information for a first color channel; means for generating a first focus map based on PD pixel information for a second color channel; means for aligning the first focus map to the reference focus map to detect a misalignment between the reference focus map and the first focus map; means for determining a magnitude of the misalignment; and means for applying chromatic aberration correction to the image information based on the detected misalignment and the magnitude of the misalignment.

In some aspects, one or more of the apparatuses described herein comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device of a vehicle), or other device. In some aspects, the apparatus(es) includes at least one camera for capturing one or more images or video frames. For example, the apparatus(es) can include a camera (e.g., an RGB camera) or multiple cameras for capturing one or more images and/or one or more videos including video frames. In some aspects, the apparatus(es) includes at least one display for displaying one or more images, videos, notifications, or other displayable data. In some aspects, the apparatus(es) includes at least one transmitter configured to transmit one or more video frame and/or syntax data over a transmission medium to at least one device. In some aspects, the at least one processor includes a neural processing unit (NPU), a neural signal processor (NSP), a central processing unit (CPU), a graphics processing unit (GPU), any combination thereof, and/or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1A illustrates a Phase Detection Auto Focus (PDAF) camera system that is in phase and therefore in focus;

FIG. 1B illustrates the PDAF camera system of FIG. 1A that is out of phase with a front focus;

FIG. 1C illustrates the PDAF camera system of FIG. 1A that is out of phase with a back focus;

FIG. 2A illustrates a top-down view of a pixel array configuration of an image sensor with masks partially covering focus pixel photodiodes;

FIG. 2B is a legend identifying elements of FIG. 2A;

FIG. 2C illustrates a top-down view of a pixel array configuration of an image sensor with two side-by-side focus pixels covered by a 2 pixel by 1 pixel microlens;

FIG. 2D illustrates a top-down view of a pixel array configuration of an image sensor with four neighboring focus pixels covered by a 2 pixel by 2 pixel microlens;

FIG. 2E illustrates a top-down view of a pixel array configuration of an image sensor in which at least one focus pixel has two photodiodes;

FIG. 2F illustrates a top-down view of a pixel array configuration of an image sensor in which at least one focus pixel has four photodiodes;

FIG. 3A illustrates a side view of a single pixel of a pixel array of an image sensor that is partially covered with a mask;

FIG. 3B illustrates a side view of two pixels of a pixel array of an image sensor, the two pixels covered by a 2 pixel by 1 pixel microlens;

FIG. 4A illustrates axial chromatic aberration;

FIG. 4B illustrates transverse chromatic aberration;

FIG. 5 is block diagram illustrating a technique for axial chromatic aberration detection, in accordance with aspects of the present disclosure;

FIG. 6 is a block diagram illustrating a technique for lateral chromatic aberration detection, in accordance with aspects of the present disclosure;

FIG. 7 is a flow diagram illustrating a process for chromatic aberration detection, in accordance with aspects of the present disclosure;

FIG. 8 is a diagram illustrating an example of a system for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the application as set forth in the appended claims.

A camera is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during the capture of one or more image frames, such as focus, ISO, exposure time, aperture size, f/stop, shutter speed, and gain. The settings or parameters can be applied to an image sensor for capturing the one or more image frames.

As an example, some cameras include automatic focusing functionality (“autofocus”) that allows the camera to focus automatically prior to capturing the desired image. Various autofocus technologies exist. Active autofocus (“active AF”) relies on determining a range between the camera and a subject of the image via a range sensor of the camera, typically by emitting infrared lasers or ultrasound signals and receiving reflections of those signals. While active AF works well in many cases and can be fairly quick, cameras with active AF can be bulky and expensive. Active AF can fail to properly focus on subjects that are very close to the camera lens (macro photography), as the range sensor is not perfectly aligned with the camera lens, and this difference is exacerbated the closer the subject is to the camera lens. Active AF can also fail to properly focus on faraway subjects, as laser or ultrasound transmitters used in the range sensors that are used for active AF are typically not very strong. Active AF also often fails to properly focus on subjects on the other side of a window than the camera, as the range sensor typically determines the range to the window rather than to the subject. Additionally, active AF may be calibrated to accurately map a lens position to a measured distance, which may be more expensive/slower to manufacture.

Passive autofocus (“passive AF”) uses the camera's own image sensor to focus the camera, and thus does not require additional sensors to be integrated into the camera. Passive AF techniques include Contrast Detection Auto Focus (CDAF), Phase Detection Auto Focus (PDAF), and in some cases hybrid systems that use both.

In CDAF, the lens of a camera moves through a range of lens positions, typically with pre-specified distance intervals between each tested lens position, and attempts to find a lens position at which contrast between the subject's pixels and background pixels are maximized. CDAF relies on trial and error and has high latency as a result. The CDAF process also requires the motor that moves the lens to be actuated and stopped repeatedly in a short span of time every time the camera needs to focus for a photo, which puts stress on components and expends a fair amount of battery power. The camera can still fail to find a satisfactory focus using CDAF, for example if the distance interval between tested lens positions is too large, as the ideal focus may actually be between tested lens positions. CDAF may also struggle in images of subjects without high-contrast features, such as walls, or in images taken in low-light or high-light conditions where lighting conditions fade or blend features that would have higher contrast in different lighting conditions.

In PDAF, photodiodes within the camera are used to check whether light that is received by the lens of a camera from different angles converge to create a focused image that is “in phase” or fails to converge and thus creates a blurry images that is “out of phase.” If light received from different angles is out of phase, the camera identifies a direction in which the light is out of phase to determine whether the lens needs to be moved forward or backward, and identifies a phase disparity indicating how out of phase the light is to determine how far the lens must be moved. In some cases, the lens is moved to the position corresponding to optimal focus.

Cameras are increasingly being added to many devices as cameras becomes smaller. However, as camera sizes decrease, a size of the image sensor on which the lens(es) may focus light may become smaller. To help provide a certain field of view, such as a 35 mm equivalent field of view, with a smaller image sensor, one or more lens(es) with a relatively shorter focal length may be used. The focal length of a lens may describe how strongly the lens focuses light and a shorter the focal length, the sharper a light ray may be bent to bring the light to focus in a shorter distance. However cameras with a relatively shorter focal length may have more issues with chromatic aberrations (CA). While CA may be addressed by using optical doublets and/or other optical element (e.g., additional lens, glass types, etc.), or software based post-processing, such techniques can increase costs and/or processing power. In some cases, it may be useful to leverage existing hardware for processing phase detection (PD) pixels (e.g., focus pixels) to help detect and/or correct for CA.

Systems, apparatuses, methods (also referred to as processes or techniques), and computer-readable media (collectively referred to herein as “systems and techniques”) are described herein for a focus pixel aided CA correction system. For example, a PDAF system may generate PD pixel information, such as a measurement of a light intensity associated with a certain color channel, for each photodiode of a PD pixel. For example, a PD pixel may include two or more photodiodes utilizing a common microlens and color filter and the PD pixel may capture light intensity information based on the color filter for each photodiode of the PD pixel. Based on a difference between the light intensity information for the photodiodes of the PD pixel, a focus map may be generated indicating how well focused each PD pixel is. Focus maps may be generated for each color PD pixel. For example, if the image sensor includes red (R), green (G), and blue (B) PD pixels, then R, G, and B focus maps may be generated. Generally, PDAF system may focus based on one reference color, such as green, and the focus map for this color may be used as a reference focus map. The other focus maps may be aligned to the reference focus map and misalignment between the focus map and the reference focus map may indicate that CA is present. How misaligned the focus maps are may indicate a magnitude of the CA. The misalignment and CA magnitude information may be used a CA correction algorithm to correct for the CA.

Various aspects of the techniques described herein will be discussed below with respect to the figures.

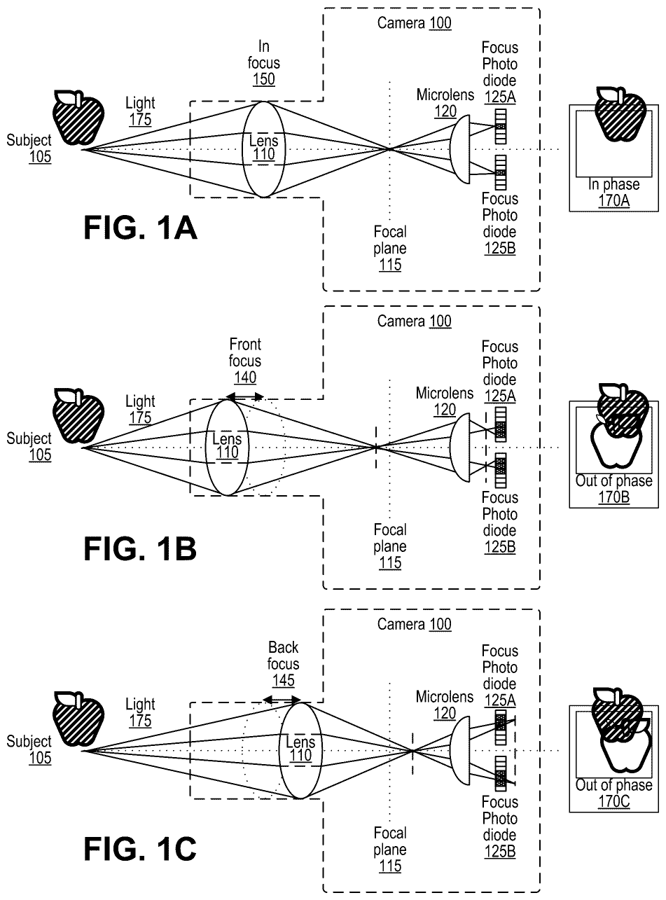

FIG. 1A illustrates a Phase Detection Auto Focus (PDAF) camera system that is in phase and therefore in focus. Rays of light 175 may travel from a subject 105 (e.g., an apple) through a lens 110 that focuses a scene with the subject 105 onto an image sensor (not pictured in its entirety), where the image sensor includes the focus photodiode 125A and the focus photodiode 125B, which correspond to focus pixels. The focus photodiodes 125A and 125B may be associated with one or two focus pixels (e.g., focus photodiode 125A and focus photodiode 125B may be two photodiodes of a single focus pixel sharing a single microlens 120 or focus photodiode 125A may be associated with a first focus pixel and focus photodiode 125B may be associated with a second focus pixel, both focus pixels sharing a single microlens 120) of the pixel array of the image sensor. In some cases, the rays of light 175 may travel through a microlens 120 before falling on the focus photodiode 125A and the focus photodiode 125B. When the camera system 100 is in the “in focus” state 150 of FIG. 1A, the rays of light 175 may ultimately converge at a plane that corresponds to the position of the focus photodiode 125A and the focus photodiode 125B. When the camera system 100 is in the “in focus” state 150 of FIG. 1A, rays of light 175 may also converge at a focal plane 115 (also known as an image plane) after passing through the lens 110 but before reaching the microlens 120 and/or focus photodiodes 125A and 125B.

Because the camera system 100 of FIG. 1A is in an in-focus state 150, data from focus photodiodes 125A and 125B is aligned, here represented by an image 170A showing a clear and sharp representation of the subject 105 due to this alignment, as opposed to the misaligned representations of the subject 105 caused by the out-of-phase states 140 and 145 in FIG. 1B and FIG. 1C respectively. The in-focus state 150 may also be referred to as an “in-phase” state, as the data from focus photodiode 125A and the focus photodiode 125B have no phase disparity, or have very little phase disparity (e.g., phase disparity falling below a predetermined phase disparity threshold).

FIG. 1B illustrates the PDAF camera system of FIG. 1A that is out of phase with a front focus. The PDAF camera system 100 of FIG. 1B is the same as the PDAF camera system 100 of FIG. 1A, but the lens 110 is moved closer to the subject 105 and further from the focus photodiodes 125A and 125B, and is therefore in a “front focus” state 140. The lens position for the “in focus” state 150 is still drawn in FIG. 1B as a dotted outline for reference, with a double-sided arrow indicating movement of the lens between the “front focus” state 140 lens position and the “in focus” state 150 lens position.

When the camera system 100 is in the “front focus” state 140 of FIG. 1B, the rays of light 175 may ultimately converge at a plane (denoted by a dashed line) before the position of the focus photodiode 125A and the focus photodiode 125B, that is, between the microlens 120 and the focus photodiodes 125A and 125B. The rays of light 175 may also converge at a position (denoted by another dashed line) before the focal plane 115 after passing through the lens 110 but before reaching the microlens 120 and/or focus photodiodes 125A and 125B. Because the light 175 in the camera system 100 of FIG. 1B is out of phase in the “front focus” state 140, data from focus photodiodes 125A and 125B is misaligned, here represented by an image 170B showing misaligned black-colored and white-colored representations of the subject 105, where the direction of misalignment in the image 170B is related to the front focus state 140, and the distance of misalignment in the image 170B is related to the distance of the lens 110 from its position in the “in focus” state 150.

FIG. 1C illustrates the PDAF camera system of FIG. 1A that is out of phase with a back focus. The PDAF camera system 100 of FIG. 1C is the same as the PDAF camera system 100 of FIG. 1A, but the lens 110 is moved further from the subject 105 and closer to the focus photodiodes 125A and 125B, and is therefore in a “back focus” state 145 (also known as a “rear focus” state). The lens position for the “in focus” state 150 is still drawn as a dotted outline for reference, with a double-sided arrow indicating movement of the lens between the “back focus” state 145 lens position and the “in focus” state 150 lens position.

When the camera system 100 is in the “back focus” state 145 of FIG. 1C, the rays of light 175 may ultimately converge at a plane (denoted by a dashed line) beyond the position of the focus photodiode 125A and the focus photodiode 125B. The rays of light 175 may also converge at a position (denoted by another dashed line) beyond the focal plane 115 after passing through the lens 110 but before reaching the microlens 120 and/or focus photodiodes 125A and 125B. Because the rays of light 175 in the camera system 100 of FIG. 1C is out of phase in the “back focus” state 145, data from focus photodiodes 125A and 125B is misaligned, here represented by an image 170C showing misaligned black-colored and white colored representations of the subject 105, where the direction of misalignment in the image 170C is related to the back focus state 145, and the distance of misalignment in the image 170C is related to the distance of the lens 110 from its position in the focused state.

When the rays of light 175 converge before the plane of the focus photodiodes 125A and 125B as in the front focus state 140 or beyond the plane of the focus photodiodes 125A and 125B as in the back focus state 145, the resulting image produced by the image sensor may be out-of-focus or blurred. In the case that the image is out-of-focus, the lens 110 can be moved forward (toward the subject 105 and away from the photodiodes 125A and 125B) if the lens 110 is in the back focus state 145, or can be moved backward (away from the subject 105 and toward the photodiodes 125A and 125B) if the lens is in the front focus state 140. The lens 110 may be moved forward or backward within a range of positions which in some cases has a predetermined length L representing a possible range of motion of the lens in the camera system 100. The camera system 100, or a computing system therein, may determine a distance and direction of adjusting the position of the lens 110 to bring the image into focus based on one or more phase disparity values calculated as differences between data from two focus photodiodes that receive light from different directions, such as focus photodiodes 125A and 125B. The direction of movement of the lens 110 may correspond to a direction in which the data from the focus photodiodes 125A and 125B is determined to be out of phase, or whether the phase disparity is positive or negative. The distance of movement of the lens 110 may correspond to a degree or amount to which the data from the focus photodiodes 125A and 125B is determined to be out of phase, or the absolute value of the phase disparity.

The camera system 100 may include motors (not pictured) that move the lens 110 between lens positions corresponding to the different states (e.g., front focus state 140, back focus state 145, and in focus state 150) and motor actuators (not pictured) that the computing system within the camera activates to actuate the motors. The camera system 100 of FIG. 1A, FIG. 1B, and FIG. 1C may in some cases also include various additional non-illustrated components, such as lenses, mirrors, partially reflective (PR) mirrors, prisms, photodiodes, image sensors, and/or other components sometimes found in cameras or other optical equipment. In some cases, the focus photodiodes 125A and 125B may be referred to as PDAF photodiodes, PDAF diodes, phase detection (PD) photodiodes, PD diodes, PDAF pixel photodiodes, PDAF pixel diodes, PD pixel photodiodes, PD pixel diodes, focus pixel photodiodes, focus pixel diodes, pixel photodiodes, pixel diodes, or in some cases simply photodiodes or diodes.

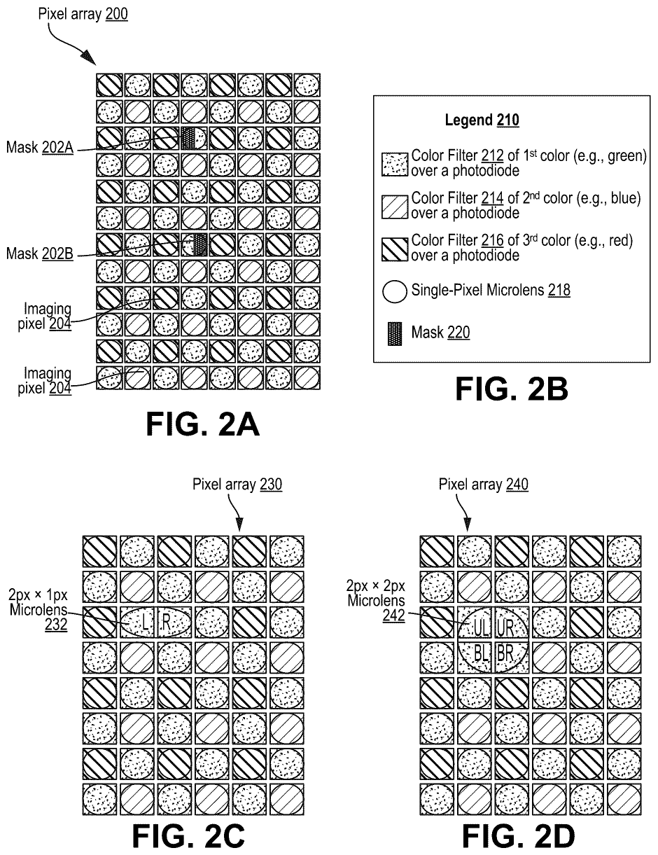

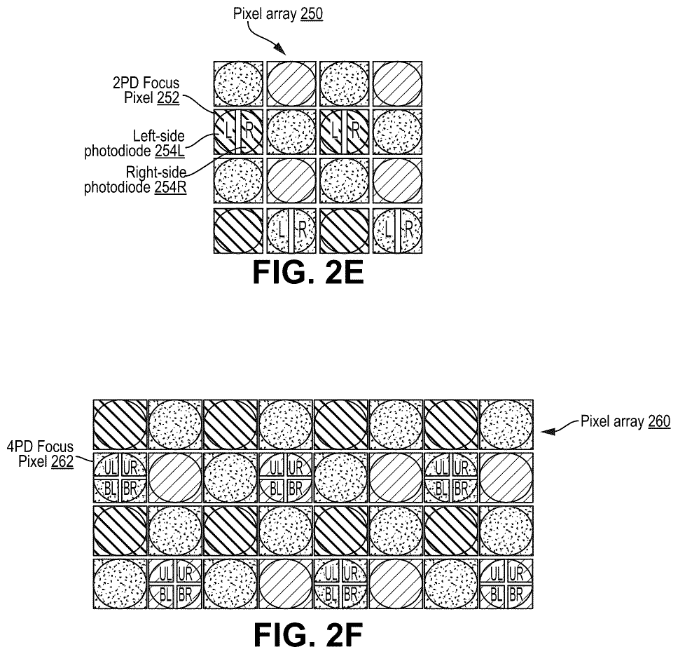

FIG. 2A illustrates a top-down view of a pixel array configuration of an image sensor with masks partially covering focus pixel photodiodes. An image sensor of a camera system may include an array of pixels, such as the pixel array 200 of FIG. 2A. The pixel array 200 may include an array of photodiodes, which is not shown in FIG. 2A as is the photodiodes are covered by color filters (e.g., Bayer filters or other types of color filters as discussed below) and microlenses 218 as identified in the legend 210 of FIG. 2B. Photodiodes of focus pixels are also partially covered by masks 220 in the pixel array 200 of FIG. 2A.

FIG. 2B is a legend identifying elements of FIG. 2A. The legend 210 identifies that a circle represents a microlens 218 of a single pixel, and that a dark shaded rectangle represents a mask 220. The legend 210 of FIG. 2B also identifies that squares with three different patterns each represent color filters 212, 214, and 216, each color filter being for one of three different colors: red, green, or blue. That is, squares of the first pattern represent a color filter 212 for a first color, which may for example be green; squares of the second pattern represent a color filter 214 for a second color, which may for example be blue; and squares of the third pattern represent a color filter 216 for a third color, which may for example be red. These color filters are arranged in color filter arrays (CFAs) over an array of photodiodes in the pixel arrays 200, 230, and 240 of FIG. 2A, FIG. 2C, and FIG. 2D respectively. The colors (and number of colors) identified in the legend 210 of FIG. 2B, and the arrangements of color filters illustrated in the pixel arrays 200, 230, and 240 of FIG. 2A, FIG. 2C, and FIG. 2D, should be understood to be exemplary and should not be construed as limiting. Red, green, and blue color filters are traditionally used in image sensors and are often referred to as Bayer filters. Bayer filter CFAs often include more green Bayer filters than red or blue Bayer filters, for example in a proportion of 50% green, 25% red, 25% blue, to mimic sensitivity to green light in human eye physiology. Bayer filter CFAs with these proportions are sometimes referred to as BGGR, RGBG, GRGB, or RGGB, and are reflected in the presence of the color filter 212 in higher proportion than the color filters 214 and 216 in the pixel arrays 200, 230, and 240 of FIG. 2A, FIG. 2C, and FIG. 2D. Sometimes, in such Bayer filter CFAs, green is treated as two colors, labeled “Gr” and “Gb” respectively. Some CFAs use alternate color schemes and can even include more or fewer colors. For example, some CFAs use cyan, yellow, and magenta color filters instead of the traditional red, green, and blue Bayer color filter scheme. In an arrangement referred to as cyan yellow yellow magenta (CYYM), 50% of the color filters are yellow, while 25% are cyan and 25% are magenta. Some filters also add a fourth green filter to the three cyan, yellow, and magenta filters, together referred to as a cyan yellow green magenta (CYGM) filter. Some CFAs use red, green, blue and “emerald” or cyan, referred to as an RGBE color scheme. In some cases, some mix or combination of the Bayer, CYYM, CYGM, or RGBE color schemes may be used. In some cases, color filters of one or more of the colors of the Bayer, CYYM, CYGM, or RGBE color schemes may be omitted, in some cases leaving only two colors or even one color. While the legend 210 of FIG. 2B lists precisely three color filters 212, 214, and 216, and provides green, red, and blue as examples to adhere to the traditional Bayer filter color scheme, it should be understood that more than three colors or less than three colors may alternately be used in the CFA, and that the colors may vary, for example including red, green, blue, cyan, magenta, yellow, emerald, white (transparent), or some combination thereof. Some image sensors, such as the Foveon X3® sensor, may lack color filters altogether, instead opting to use different photodiodes throughout the pixel array (optionally vertically stacked), the different photodiodes having different spectral sensitivity curves and therefore responding to different wavelengths of light. Monochrome image sensors may also lack color filters and therefore lack color depth. Use of color filters in an image sensor used with the camera systems described further herein should therefore be considered optional.

The pixel array 200 of FIG. 2A is illustrated with two pixels that are used for phase detection auto focus (PDAF), which are referred to herein as focus pixels, but may alternately be referred to as PDAF pixels or phase detection (PD) pixels. Other pixels not used for PDAF may simply be referred to as imaging pixels 204. In the pixel array 200 of FIG. 2A, any pixel without a mask 220 is an imaging pixel 204, even though only two imaging pixels 204 are specifically labeled. While two focus pixels are illustrated in the pixel array 200 of FIG. 2A, both in the same column but with three rows of imaging pixels in between, a different pixel array (not pictured) may have any number of focus pixels (i.e., one or more focus pixels), which may be arranged in any possible pattern or arrangement. In some cases, patterns of focus pixels may repeat across a pixel array, for example in “tiles” that are 8 pixels by 8 pixels in size, or 16 pixels by 16 pixels in size.

The two focus pixels illustrated in FIG. 2A are both partially covered by masks 220, the two masks 220 labeled as mask 202A and mask 202B, respectively. Each of the masks 220 may be a mask or shield made of an opaque and/or reflective material, such as a metal. Each mask 220 limits the amount and direction of light that strikes the photodiode of the focus pixel that is partially covered by the mask. The mask 202A and mask 202B each limit how much light reaches and strikes the underlying focus pixel photodiode from a particular direction, and are disposed over two different focus pixel diodes in an opposite direction to produce a pair of left and right images. For example, the mask 202A is disposed over a left side of a first focus pixel, leaving the right side of that first focus pixel to receive light entering from the right side (the right image). The mask 202B is disposed over a right side of a second focus pixel, leaving the left side of that second focus pixel to receive light entering from the left side (the left image). Because the two focus pixels are both illustrated as half-covered by the masks 220, their focus photodiodes effectively receive 50% of the light that an imaging photodiode (which would not be covered by a mask) in the same location on the pixel array would receive.

Any number of focus pixels may be included in a pixel array of an image sensor. Left and right pairs of focus pixels may be adjacent to one another, or may be spaced apart by one or more imaging pixels 204. The two pixels from a left and right pair of focus pixels may both be in the same row and/or same column of the pixel array, may be in a different row and/or different column, or some combination thereof. While masks 202A and 202B are shown within pixel array 200 as masking left and right portions of the focus pixel photodiodes, this is for exemplary purposes only. Focus pixel masks 220 may instead mask top or bottom portions of the focus pixel photodiodes, thus generating top and bottom images (or “up” and “down” images) from the focus pixel data received by the focus pixels. Like the left and right pairs of focus pixels, top and down pairs of focus pixels may both be in the same row and/or same column of the pixel array, may be in a different row and/or different column, or some combination thereof. A pixel array of an image sensor may have a focus pixel with a mask 220 over a left side of one focus pixel, a mask 220 over a right side of a second focus pixel, a mask 220 over a top side of a third focus pixel, a mask 220 over a bottom side of a fourth focus pixel, and optionally more focus pixels with any of these types of masks 220. Using focus pixels with masks 220 along multiple axes (e.g., left-right pairs of focus pixels as well as top-down pairs of focus pixels) can improve autofocus quality. One reason why autofocus quality can be improved by using focus pixels with masks 220 along multiple axes is because use of masks 220 along left and right sides of focus pixel photodiodes alone for PDAF can lead to poor focus on scenes or subjects with many horizontal edges (i.e., lines that appear along a left-right axis relative to the orientation of the focus pixels and masks 220), and use of masks 220 along top and bottom sides of focus pixel photodiodes alone for PDAF can lead to poor focus on scenes or subjects with many vertical edges (i.e., lines that appear along an up-down axis relative to the orientation of the focus pixels and masks 220).

Some PDAF camera systems do not use masks 220 on focus pixels as in FIG. 2A, but instead cover multiple pixels under a single microlens, which may alternately be referred to as an on-chip lens (OCL). FIG. 2C illustrates a top-down view of a pixel array configuration with two side-by-side focus pixels covered by a 2 pixel by 1 pixel microlens. FIG. 2D illustrates a top-down view of a pixel array configuration with four neighboring focus pixels covered by a 2 pixel by 2 pixel microlens. The pixel arrays 230 and 240 of FIG. 2C and FIG. 2D can also be interpreted based on the legend 210 of FIG. 2B.

Referring to FIGS. 2C and 2D, the 2 pixel by 1 pixel microlens 232 of FIG. 2C and the 2 pixel by 2 pixel microlens 242 of FIG. 2D both span multiple adjacent focus pixels (i.e., the microlenses cover multiple adjacent focus pixel photodiodes), and both can limit the amount and/or direction of light that strikes the focus pixel photodiodes of those focus pixels. The microlens 232 of FIG. 2C covers two horizontally-adjacent focus pixels of a pixel array 230, such that focus pixel data from both focus photodiodes may be generated, with focus pixel data from the left one of the focus pixels (labeled with an “L”) representing light approaching from the left side of the pixel array 230, and focus pixel data from the right one of the focus pixels (labeled with an “R”) representing light approaching from the right side of the pixel array 230. While the microlens 232 is shown within pixel array 230 as spanning left and right adjacent pixels/diodes (e.g., in a horizontal direction), this is for exemplary purposes only. A 2 pixel by 1 pixel microlens 232 may instead span top and bottom adjacentpixels/diodes (e.g., in a vertical direction), thus generating an up and down (or top and bottom) pair of focus photodiodes and corresponding pixel data.

Similarly, the microlens 242 of FIG. 2D covers a 2-pixel by 2-pixel square of four adjacent focus pixels of a pixel array 240, such that focus pixel data from all four photodiodes in the square may be generated. The focus pixel data from the four adjacent focus pixels thus includes focus pixel data from an upper-left pixel (labeled “UL” in FIG. 2D) representing light approaching from the upper-left of the pixel array 240, focus pixel data from an upper-right pixel (labelled “UR” in FIG. 2D) representing light approaching from the upper-right of the pixel array 240, focus pixel data from a bottom-left pixel (labeled “BL” in FIG. 2D) representing light approaching from the bottom-left of the pixel array 240, and focus pixel data from a bottom right pixel (labeled “BR” in FIG. 2D) representing light approaching from the bottom right of the pixel array 240. The configurations of pixel arrays 230 and 240 of FIG. 2C and FIG. 2D are exemplary; any number of focus pixels may be included within a pixel array, and may include one or more horizontally-oriented (left-right) 2-pixel by 1-pixel microlenses 232, one or more vertically-oriented (up-down) 2-pixel by 1-pixel microlenses 232, one or more 2-pixel by 2-pixel microlenses 242, or different combinations thereof.

Again referring to FIGS. 2C and 2D, once the pixel array captures a frame, thus capturing focus pixel data for each focus pixel, focus pixel data from paired focus pixels may be compared with one another. For example, focus pixel data from a left focus pixel photodiode may be compared with focus pixel data from a right focus pixel photodiode, and focus pixel data from a top focus pixel photodiode may be compared with focus pixel data from a bottom focus pixel photodiode. If the compared focus pixel data values differ, this difference is known as the phase disparity, also known as the phase difference, defocus value, or separation error. Focus pixels under a 2-pixel by 2-pixel microlens 242 as in FIG. 2D essentially have two vertically-adjacent horizontally-oriented pairs of focus pixels and/or two horizontally-adjacent vertically-oriented pairs of focus pixels. Thus, the focus pixel data from the UL focus pixel may be compared to focus pixel data from the BL focus pixel (as a top/bottom pair), focus pixel data from the UR focus pixel may be compared to focus pixel data from the BR focus pixel (as a top/bottom pair), focus pixel data from the UL focus pixel may be compared to focus pixel data from the UR focus pixel (as a left/right pair), focus pixel data from the BL focus pixel may be compared to focus pixel data from the BR focus pixel (as a left/right pair), or some combination thereof. In some cases, focus pixel data may alternately or additionally be compared between pixels that are opposite each other diagonally (along two axes). For example, focus pixel data from the UL focus pixel focus may be compared to focus pixel data from the BR focus pixel, and/or focus pixel data from the BL focus pixel focus may be compared to focus pixel data from the UR focus pixel.

While the focus pixels under the 2 pixel by 1 pixel microlens 232 of FIG. 2C and the focus pixels under the 2 pixel by 2 pixel microlens 242 of FIG. 2D are all illustrated having the color filter 212 of the first color, this is not required. In some cases, the normal pattern of the CFA of the pixel array may continue under a 2 pixel by 1 pixel microlens 232 and/or under a 2 pixel by 2 pixel microlens 242.

FIG. 2E illustrates a top-down view of a pixel array configuration of an image sensor in which at least one focus pixel has two photodiodes. In particular, a four-pixel by four-pixel pixel array 250 with four focus pixels is illustrated in FIG. 2E. The four focus pixels illustrated in the pixel array 250 each include two photodiodes, with the left-side photodiode and the right-side photodiode of each focus pixel's photodiode pair labeled “L” and “R,” respectively. Focus pixels with two photodiodes, like the focus pixels of FIG. 2E, are sometimes referred to as dual photodiode (2PD) focus pixels.

One of the 2PD focus pixels of FIG. 2E is labeled as 2PD focus pixel 252. The left-side photodiode (L) of the 2PD focus pixel 252 is labeled “left-side photodiode 254L,” and the right-side photodiode (R) of the 2PD focus pixel 252 is labeled “right-side photodiode 254R.” For each captured frame, the left photodiode 254L and the right photodiode 254R may capture light received by the 2PD focus pixel 252 from different angles. For a given frame, the data captured by the left photodiode 254L may be referred to as the left image or left image data, while the data captured by the right photodiode 254R may be referred to as the right image or right image data. The left image data and the right image data may be compared to determine phase disparity.

The pixel array 250 illustrated in FIG. 2E is a “sparse” 2PD pixel array in which only some of the pixels in the pixel array 250 include two photodiodes (namely, the focus pixels). The remaining pixels are imaging pixels and only include a single photodiode. In some cases, however a “dense” 2PD pixel array may be used instead, in which every pixel in the pixel array (or a higher percentage of pixels in the pixel array) include two photodiodes, and can in some cases act as both focus pixels and imaging pixels simultaneously, or can switch between acting as a focus pixel for one frame and acting as an imaging pixel for another frame. While all of the 2PD focus pixels of FIG. 2E are shown as “horizontal” 2PD focus pixels having a left photodiode and a right photodiode, this arrangement is exemplary. A pixel array with 2PD focus pixels may additionally or alternately include “vertical” focus pixels with a top (“up”) photodiode and a bottom (“down”) photodiode and/or photodiodes that are arranged diagonally with respect to one another. Since use of only horizontal focus pixels can sometimes limit recognition of horizontal edges in images, and use of only vertical focus pixels can sometimes limit recognition of vertical edges in images, use of both horizontal focus pixels and vertical focus pixels can improve focus quality by performing well even in images with many horizontal edges and/or vertical edges.

FIG. 2F illustrates a top-down view of a pixel array configuration of an image sensor in which at least one focus pixel has four photodiodes. The pixel array 260 illustrated in FIG. 2F includes focus pixels in which each focus pixel includes four diodes, generally referred to as 4PD focus pixels or Quadrature Phase Detection (QPD) focus pixels. For example, a 4PD focus pixel 262 is labeled in FIG. 2F, and includes an upper-left photodiode labeled with the letters “UL,” an upper-right photodiode labeled with the letters “UR,” a bottom-left photodiode labeled with the letters “BL,” and a bottom-right photodiode labeled with the letters “BR.” Data from each photodiode of the 4PD focus pixel 262 may be compared to data from an adjacent photodiode of the 4PD focus pixel 262 to determine phase difference. For example, photodiode data from the UL photodiode may be compared to photodiode data from the BL photodiode (as a top/bottom pair), photodiode data from the UR photodiode may be compared to photodiode data from the BR photodiode (as a top/bottom pair), photodiode data from the UL photodiode may be compared to photodiode data from the UR photodiode (as a left/right pair), photodiode data from the BL photodiode may be compared to photodiode data from the BR photodiode (as a left/right pair), or some combination thereof. In some cases, photodiode data from the 4PD focus pixel 262 may alternately or additionally be compared between photodiodes that are opposite each other diagonally (along two axes). For example, photodiode data from the UL photodiode of the 4PD focus pixel 262 may be compared to photodiode data from the BR photodiode of the 4PD focus pixel 262, and/or photodiode data from the BL photodiode of the 4PD focus pixel 262 may be compared to photodiode data from the UR photodiode of the 4PD focus pixel 262.

The pixel array 260 illustrated in FIG. 2F is a “sparse” 4PD pixel array in which only some of the pixels in the pixel array 260 include four photodiodes (namely, the focus pixels). The remaining pixels are imaging pixels and only include a single photodiode. In some cases, however a “dense” 4PD pixel array may be used instead, in which every pixel in the pixel array (or a higher percentage of pixels in the pixel array) include four photodiodes, and can in some cases act as both focus pixels and imaging pixels simultaneously, or can switch between acting as a focus pixel for one frame and acting as an imaging pixel for another frame. While all of the 4PD focus pixels of FIG. 2F are shown as “horizontal” 4PD focus pixels having a left photodiode and a right photodiode, this arrangement is exemplary. A pixel array with 4PD focus pixels may additionally or alternately include “vertical” focus pixels with a top (“up”) photodiode and a bottom (“down”) photodiode and/or photodiodes that are arranged diagonally with respect to one another. Since use of only horizontal focus pixels can sometimes limit recognition of horizontal edges in images, and use of only vertical focus pixels can sometimes limit recognition of vertical edges in images, use of both horizontal focus pixels and vertical focus pixels can improve focus quality by performing well even in images with many horizontal edges and/or vertical edges.[0076] In some cases, a pixel array may use some combination of one or more pairs of focus pixels with masks 220 (as illustrated in FIG. 2A), one or more pairs of focus pixels covered by 2-pixel by 1-pixel microlenses 232 (as illustrated in FIG. 2C), one or more groups of focus pixels covered by 2-pixel by 2-pixel microlenses 242 (as illustrated in FIG. 2D), one or more 2PD focus pixels 252 (as illustrated in FIG. 2E), and/or one or more 4PD focus pixels 262 (as illustrated in FIG. 2F). In some cases, focus pixels in any of the configurations illustrated in and discussed with respect to FIG. 2A-2F may be arranged in a vertically and/or horizontally tiled pattern, such as the tiled patterns of the 2PD and 4PD focus pixels of FIG. 2E and FIG. 2F.

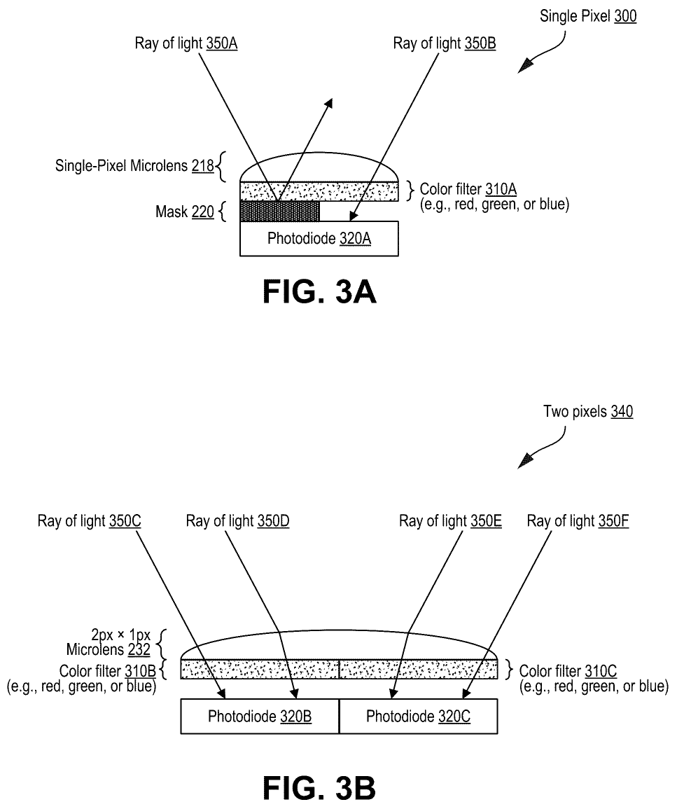

FIG. 3A illustrates a side view of a single pixel of a pixel array of an image sensor that is partially covered with a mask. The side view of the pixel 300 illustrates the single-pixel microlens 218 over a color filter 310A, which is over a mask 220, the mask 220 covering the left side of the photodiode 320A. A ray of light 350B entering from the right side of the microlens 218 passes through the color filter 310A and reaches the photodiode 320A, while ray of light 350A entering from the left side of the microlens 218 is reflected by the mask 220. While a similar pixel with the mask 220 over the right side of the photodiode 320A is not illustrated, it should be understood that this could be achieved by horizontally flipping the illustration of FIG. 3A. In an alternate embodiment, the mask 220 may be positioned above the color filter 310A and/or above the microlens 218.

FIG. 3B illustrates a side view of two pixels of a pixel array of an image sensor, the two pixels covered by a 2 pixel by 1 pixel microlens. The side view of the two pixels 340 of FIG. 3B illustrates the 2 pixel by 1 pixel microlens 232 over one color filter 310B on the left and another adjacent color filter 310C on the right, with the color filter 310B on the left over a left photodiode 320B, and the color filter 310C on the right over a right photodiode 320C. Two rays of light 350C and 350D entering from the left side of the microlens 232 pass through the left color filter 310B and reach the left photodiode 320B, while two rays of light 350E and 350F entering from the right side of the microlens 232 pass through the right color filter 310C and reach the right photodiode 320C.

Each color filter of the color filters 310A, 310B, and 310C of FIG. 3A and FIG. 3B may be a color filter of any color previously described with respect to color filters 212, 214, and 216. That is, while FIG. 3A and FIG. 3B list red, green, and blue as example colors to adhere to the traditional Bayer color scheme, each color filter of the color filters 310A, 310B, and 310C may represent another color such as cyan, yellow, magenta, emerald, or white (transparent). While the color filters 310A, 310B, and 310C all are illustrated with an identical pattern in FIG. 3A and FIG. 3B, the pattern matching the pattern of color filter 212 of FIGS. 2A-2D, the three color filters 310A, 310B, and 310C need not all represent the same color of color filter as each other, and need not represent the same color as the color filter 212 of FIGS. 2A-2D. All three color filters 310A, 310B, and 310C can be different colors, or alternately any two (or all three) can optionally share a color. Alternatively, no color filter may be included.

Cameras are increasingly being added to many devices as a size of the cameras becomes smaller. As camera sizes decrease, a size of the image sensor on which the lens(es) may focus light may become smaller. To help provide a certain field of view, such as a 35 mm equivalent field of view, with a smaller image sensor, one or more lens(es) with a relatively shorter focal length may be used. For example, generally the shorter focal length, a wider a field of view can be achieved. The focal length of a lens may describe how strongly the lens focuses light and a shorter the focal length, the sharper a light ray may be bent to bring the light to focus in a shorter distance.

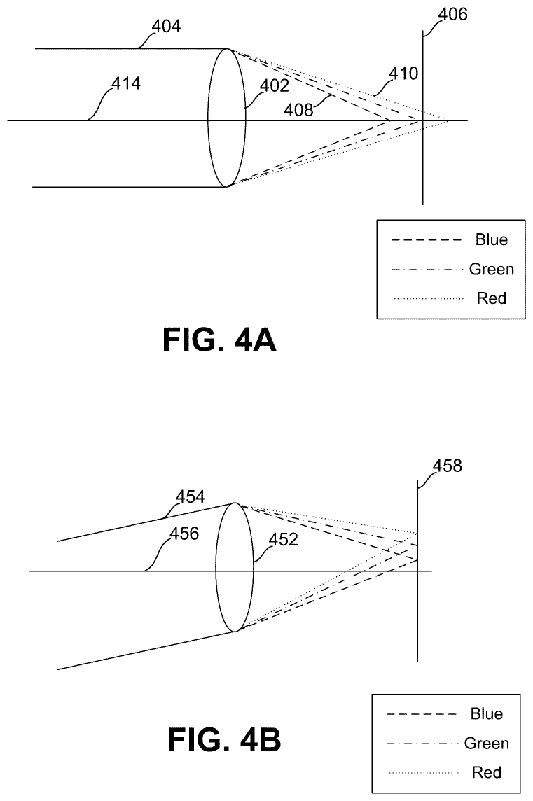

In some cases, cameras with a relatively shorter focal length may have more issues with chromatic aberrations (CA). Chromatic aberration may be a type of color distortion that can appear as color fringing where an unwanted colored outline may appear along edges of objects. Chromatic aberration may appear when different colors of light are not focused at a same point as different colored light has different wavelengths. There may be multiple types of CA. For example, as shown in FIG. 4A illustrating axial (e.g., longitudinal) CA, which is caused when a lens 402 cannot focus different colored light of straight incident light 404 onto a same point on a focal plane 406. As shown, blue light 408 has a relatively short wavelength and may be bent more by the lens 402 as compared to longer wavelength light, such as red color light 410. Thus, different colored light may be focused by the lens 402at different points in a longitudinal direction along an optical axis 414.

FIG. 4B illustrates transverse (e.g., lateral) CA. Traverse CA may occur when a lens 452 cannot focus different colored light of obliquely incident light 454 along the optical axis 456. In some cases of traverse CA, the different colored light may be focused on the same focal plane 458 but at different positions on the focal plane 458.

In some cases, traverse CA and axial CA may be addressed either by using optical doublets and/or other optical element (e.g., additional lens, glass types, etc.) to correct the CA, or software based post-processing. However, adding optical doublets/elements can increase costs and using software based post-processing can increase a processing load to detect and correct CA for each pixel, as well as calibration and/or optical modelling steps. Instead, it may be useful to leverage existing hardware for processing phase detection (PD) pixels (e.g., focus pixels) to help detect and/or correct for CA.

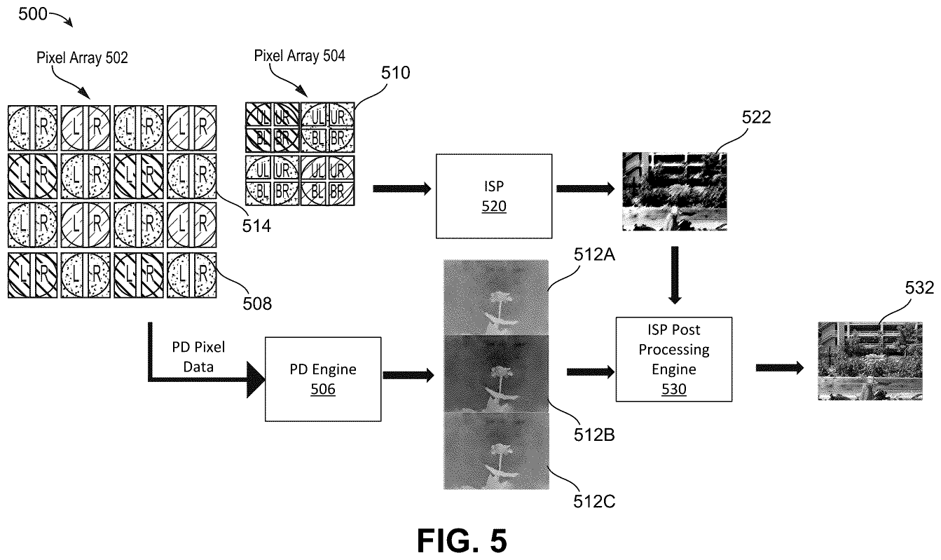

FIG. 5 is block diagram illustrating a technique for axial CA detection 500, in accordance with aspects of the present disclosure. In some cases, an image capturing device may include an image sensor with PD pixels and these PD pixels may be arranged in a 2×1 pattern (e.g., 2PD focus pixel, 2PD PD pixel), as seen in pixel array 502, or a 2×2 pattern (e.g., 4PD focus pixel, 4PD PD pixel), as seen in pixel array 502 In some cases, each pixel of the pixel array (e.g., pixel array 502 or 504) may be focus pixel. Where not every pixel on an image sensor is a focus pixel, the non-focus pixels have been omitted. In this example, the PD pixels may have red (R), green (G), or blue (B) color filters and there may be more pixels with the G color filter (e.g., G pixels) than pixels with the R or B color filters (e.g., R pixels or B pixels, respectively). Information from pixels with a common color filter may be output on a color channel. For example, information from G pixels may be output on a G color channel, information from R pixels may be output on an R color channel, and information from B pixels may be output on a B color channel.

In some cases, to detect CA in an image, an image may be captured by a pixel array, such as pixel array 502 or pixel array 504, of an image sensor. The image sensor may send out two streams of information. The first stream may include color information sent to an ISP 520 (e.g., obtained by the ISP 520). The color information may include information about light captured by non-PD pixel and PD pixels and this color information may be used to generate an image 522 that may include CA. The image 522 may be passed into an ISP post processing engine 530. In some cases, for the color information, information from the multiple photodiodes of a PD pixel may be binned (e.g., summed, averaged, or otherwise combined) to generate the color information. The second stream may include PD pixel information.

As shown in FIG. 5, the PD pixel information from the PD pixels may be passed to a PD engine 506. In some cases, the PD engine 506 may be a hardware and/or software component of an image processor which determines whether the imaging device is properly focused for capturing a scene or how to and how much to adjust, for example, a lens of the imaging device to bring the scene into focus. The PD engine 506 may receive PD pixel information, such as a measurement of a light intensity for a certain color channel, from each photodiode of a PD pixel. For example, the PD engine 506 may receive (e.g., obtain) green light intensity information from both a right photodiode and left photodiode from PD pixel 508. Similarly, where an image sensor includes 4PD PD pixels, such as PD pixel 510, the PD engine 506 may receive green light intensity information from an upper left, upper right, bottom left, and bottom right photodiodes. Phase information may be derived based on, for example, differences in light intensity as between the photodiodes of a PD pixel and the phase information may be use for PDAF.

In some cases, this difference in light intensity as between two photodiodes may be used to generate a focus map for each color channel. For example, the PD engine 506 may generate a red focus map 512A using light information from the R PD pixels, green focus map 512B using light information from the G PD pixels, and blue focus map 512C using light information from the B PD pixels (collectively focus maps 512). The difference in light intensity as between two or more photodiodes may indicate how well a particular pixel is focused. In focus maps 512, lighter areas represent more well focused areas which may have less differences as between the photodiode values (e.g., intensity values for a certain color). In contrast, darker areas may have more differences as between the photodiode values and are thus less well focused. In some cases, the differences in light intensity may be determined for multiple directions. For example, a horizontal difference may be determined based on the left photodiode and right photodiode of a PD pixel, such as PD pixel 508. Where 2PD pixels are used, a vertical difference may be determined based on photodiodes of multiple PD pixels, such as a left (or right, or both) photodiode of PD pixel 508 and a corresponding left (or right, or both) photodiode of PD pixel 514. Where 4PD pixels are used, vertical, horizontal, and/or diagonal differences may be determined using photodiodes of a single PD pixel. In some cases, a focus map, such as the green focus map 512B may be downscaled (or the other color focus maps upscaled) to help compensate for the larger number of green PD pixels.

In some cases, CA may be detected, for the captured image 522 based on differences as between a focus map for a color channel as compared to a reference focus map for a given direction. In some cases, the green color channel focus map may be used as the reference focus map as PDAF systems may often focus using information from the G pixels (e.g., from a G color channel) as there are usually more G pixels, for example, in a Bayer pattern. In some cases, other color focus maps, such as the red focus map 512A or blue focus map 512C, may be compared as against the green focus map 512B as the reference. For example, for a set of focus maps which compare photodiodes in a horizontal direction, if portions of the red focus map 512A does not align within a threshold distance of corresponding portions of the green focus map 512B (e.g., detecting a misalignment between focus maps 512) then CA may be detected in the horizontal direction in those portions which are not aligning for the captured image 522. The threshold distance may be based on a pixel shift in a sensor's native resolution. In some cases, one pixel shift difference threshold between a reference color channel focus map and other color channel focus map can be used to detect a chromatix aberration. For example, for a green reference, red and/or blue color components from neighboring pixels can mix with the green color component and show color fringes on the edges. In some examples, alignment of the focus maps 512 may be performed in multiple directions (e.g., horizontal, vertical, diagonal, etc.). As the focus maps 512 may be generated on a per pixel basis, the aligning of the focus maps 512 may be performed on a per-pixel basis for the focus maps 512. The alignment of the focus maps may be based on where the image is focused (e.g., on a region of interest, focused area, etc.). For example, an image may contain multiple objects and the image may be focused on a single object such that the object is in focus while other objects are defocused. The object in focus may be indicated based on the reference channel (e.g., the color channel used for PDAF) and the alignment as between the focus maps 512 may be performed based on the object in focus.

In some cases, how much of an alignment difference (e.g., magnitude of the misalignment, such as a 2 pixel shift, 4 pixel shift, etc.) between, for example, red focus map 512A and the green focus map 512B or blue focus map 512C and the green focus map 512B, may indicate how much CA correction may be used. CA information about which color channel on which CA has been detected (e.g., based on which color focus maps 512 are not aligning) and how much CA (e.g., magnitude of the difference between focus maps 512) has been detected may be passed to the ISP post processing engine 530.

Based on the CA information and image 522, the ISP post processing engine 530 may apply one or more CA correction algorithms to color channels of the image where CA has been detected based on the magnitude of the CA detected on those color channels (e.g., how much CA correction to apply to the color channels) to generate a corrected image 532 for output. In some cases, the CA correction algorithm may be any know CA correction algorithm supported by the ISP post processing engine 530. For example, where CA is detected on a red color channel (e.g., where the red focus map 512A does not align with the green focus map 512B), the ISP post processing engine 530 may sharpen the red color channel based on the magnitude of the CA detected. In some cases, the CA correction algorithm may be applied globally across the image 522 to correct for axial C based on the information provided by the PD engine 506A. For example, the ISP post processing engine 530 may execute a CA correction algorithm based on the information provided by the PD engine 506.

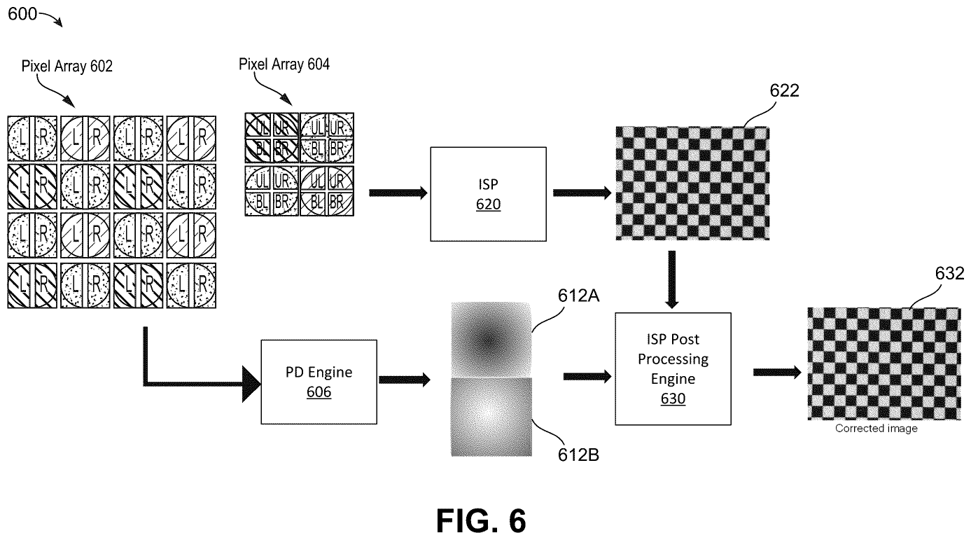

FIG. 6 is a block diagram illustrating a technique for lateral CA detection 600, in accordance with aspects of the present disclosure. In some cases, an amount of CA may vary across an image. For example, a lens may produce well focused images with little CA near a center of an image, but the amount of CA may increase the further a pixel is from the center of the image. To account for different amounts of CA across an image, shift maps 612 (e.g., R-G shift map 612A, B-G shift map 612B, collectively, shift maps 612) for the focus maps may be determined. For example, as described in FIG. 5, an image may be captured by a pixel array, such as pixel array 602 or pixel array 604, of an image sensor. The image sensor may send out two streams of information. The first stream may include color information sent to an ISP 620. The color information may include information about light captured by non-PD pixel and PD pixels and this color information may be used to generate an image 622 that may include CA. The image 622 may be passed into an ISP post processing engine 630.

As described above with respect to FIG. 5, the PD pixel information from the PD pixels (e.g., as shown in pixel array 602 or pixel array 604) may be passed to a PD engine 506. The PD engine 506 may generate a focus map (not shown) for each color channel and analyze the focus maps to determine how shifted portions of a particular color focus map is from a reference focus map. For example, the G color channel focus map may be used as the reference focus map and other color channel (e.g., R/B) focus maps may be compared to the G color channel focus map to determine a pixel by pixel (or portion by portion) alignment between pixels of the of the other color channel focus maps and the G color channel focus map. The shift map may represent the alignment between pixels of the of the other color channel (e.g., R/B) focus maps and the G color channel focus map. In some cases, both a R-G shift map 612A (e.g., comparing the R color channel focus map to the G color channel focus map) and a B-G shift map 612B (e.g., comparing the B color channel focus map to the G color channel focus map) may be determined. The determined shift maps 612 may be passed to the ISP post processing engine 630.

Based on the shift maps 612 and image 622, the ISP post processing engine 630 may apply one or more CA correction algorithms to color channels of the image where CA has been detected. For example, as granular information (e.g., per pixel, per portion, etc.) on how much a pixel is shifted as between the color channels is available, a post processing algorithm to correct CA that spatially warps (e.g., rescale) the different color channels dynamically (e.g., based on position of the pixel in the image) based on the shift maps 612 may be used. For example, a post processing algorithm to correct CA may rescale the R/B color channels to align with the G color channel on a per pixel basis based on a corresponding shift map location. In some cases, as the technique for lateral CA detection 600 can be performed on a more granular level (e.g., pixel by pixel, portion by portion, etc.), rather than a global correction, the technique for lateral CA detection 600 may be used to correct for both axial CA and lateral CA. After CA correction is applied to image 622, the ISP post processing engine 630 may generate a corrected image 632 for output.

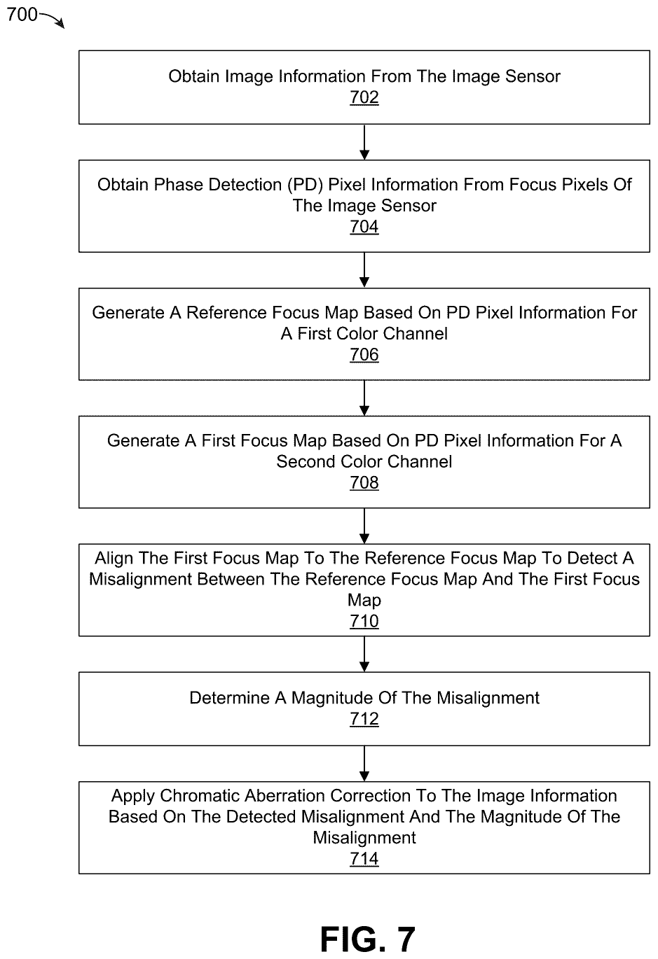

FIG. 7 is a flow diagram illustrating a process 700 for CA detection, in accordance with aspects of the present disclosure. The process 700 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 700 may be implemented as software components that are executed and run on one or more processors.

At block 702, the computing device (or component thereof) may obtain image information from an image sensor including an array of pixels, the array of pixels (e.g., pixel array 200, pixel array 230, pixel array 240, pixel array 250, pixel array 260 of FIG. 2A-2F pixel array 502, pixel array 504 of FIG. 5, pixel array 602, pixel array 604 of FIG. 6, etc.) including focus pixels (e.g., focus photodiode 125A and the focus photodiode 125B of FIG. 1A-1C, 2PD focus pixel 252 and 4PD focus pixel 262 of FIG. 2, etc.). In some cases, the computing device may include the image sensor.

At block 704, the computing device (or component thereof) may obtain phase detection (PD) pixel information from the focus pixels of the image sensor.

At block 706, the computing device (or component thereof) may generate a reference focus map (e.g., focus maps 512 of FIG. 5) based on PD pixel information for a first color channel. In some cases, the focus map may be based on light intensity information from the photodiodes of a focus pixel. In some examples, the first color channel comprises a color channel used for focusing. In some cases, the first color channel comprises a green color channel.

At block 708, the computing device (or component thereof) may generate a first focus map based on PD pixel information for a second color channel. In some examples, the computing device (or component thereof) may generate focus maps based on a difference in light intensity between two or more photodiodes of one or more focus pixels. In some cases, the second color channel comprises one or a red or blue color channel. In some examples, the computing device (or component thereof) may generate a shift map based on an alignment between pixels of the first focus map and the reference focus map. The shift map may represent the alignment between pixels of the of the second color channel focus maps and the first color channel focus map. In some cases, applying the chromatic aberration correction comprises warping the second color channel based on the shift map. In some examples, the second color channel is warped on a per pixel basis.

At block 710, the computing device (or component thereof) may align the first focus map to the reference focus map to detect a misalignment between the reference focus map and the first focus map. In some examples, alignment of the focus maps may be performed in multiple directions. In some cases, alignment of the focus maps may be based on where the image is focused (e.g., on a region of interest, focused area, etc.). In some cases, the computing device (or component thereof) may align the first focus map to the reference focus map based on a focused area.

At block 712, the computing device (or component thereof) may determine a magnitude of the misalignment. In some cases, how much of an alignment difference between the focus maps may indicate how much CA correction may be used.

At block 714, the computing device (or component thereof) may apply chromatic aberration correction to the image information based on the detected misalignment and the magnitude of the misalignment. In some cases, the computing device (or component thereof) may apply the chromatic aberration correction by sharpening the second color channel based on the magnitude of the misalignment. In some cases, chromatic aberration correction may be applied to the second color channel as the first color channel may be a color channel used for PDAF.

In some cases, the devices or apparatuses configured to perform the operations of the process 700 and/or other processes described herein may include a processor, microprocessor, microcomputer, or other component of a device that is configured to carry out the steps of the process 700 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 700 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 700 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 700 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

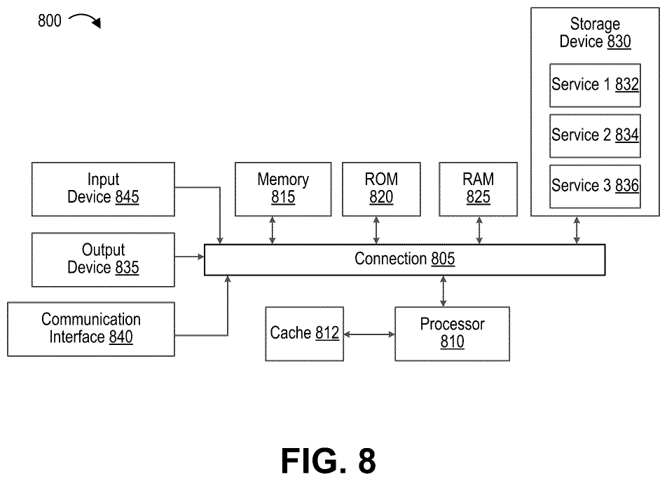

FIG. 8 is a diagram illustrating an example of a system for implementing certain aspects of the present technology. In particular, FIG. 8 illustrates an example of computing system 800, which can be for example any computing device making up internal computing system, a remote computing system, a camera, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 800 includes at least one processing unit (CPU or processor) 810 and connection 805 that couples various system components including system memory 815, such as read-only memory (ROM) 820 and random access memory (RAM) 825 to processor 810. Computing system 800 can include a cache 812 of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning@port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some embodiments, a hardware service that performs a particular function can include the software component stored in a computer-readable medium in connection with the necessary hardware components, such as processor 810, connection 805, output device 835, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus, comprising: at least one memory; and at least one processor coupled to the at least one memory, the at least one processor configured to: obtain image information from an image sensor including an array of pixels, the array of pixels including focus pixels; obtain phase detection (PD) pixel information from the focus pixels of the image sensor; generate a reference focus map based on PD pixel information for a first color channel; generate a first focus map based on PD pixel information for a second color channel; align the first focus map to the reference focus map to detect a misalignment between the reference focus map and the first focus map; determine a magnitude of the misalignment; and apply chromatic aberration correction to the image information based on the detected misalignment and the magnitude of the misalignment.
Aspect 2. The apparatus of Aspect 1, wherein, to apply the chromatic aberration correction, the at least one processor is further configured to sharpen the second color channel based on the magnitude of the misalignment.
Aspect 3. The apparatus of any of Aspects 1-2, wherein the at least one processor is further configured to generate a shift map based on an alignment between pixels of the first focus map and the reference focus map.
Aspect 4. The apparatus of Aspect 3, wherein, to apply the chromatic aberration correction, the at least one processor is further configured to warp the second color channel based on the shift map.
Aspect 5. The apparatus of Aspect 4, wherein the at least one processor is configured to warp the second color channel on a per pixel basis.
Aspect 6. The apparatus of any of Aspects 1-5, wherein the at least one processor is further configured to generate focus maps based on a difference in light intensity between two or more photodiodes of one or more focus pixels.
Aspect 7. The apparatus of any of Aspects 1-6, wherein the at least one processor is further configured to align the first focus map to the reference focus map based on a focused area.
Aspect 8. The apparatus of any of Aspects 1-7, wherein the first color channel comprises a color channel used for focusing.
Aspect 9. The apparatus of Aspect 8, wherein the first color channel comprises a green color channel.
Aspect 10. The apparatus of any of Aspects 1-9, wherein the second color channel comprises one or a red or blue color channel.
Aspect 11. The apparatus of any of Aspects 1-10, further comprising the image sensor.
Aspect 12. A method for image correction, comprising: obtaining image information from an image sensor including an array of pixels, the array of pixels including focus pixels; obtaining phase detection (PD) pixel information from the focus pixels of the image sensor; generating a reference focus map based on PD pixel information for a first color channel; generating a first focus map based on PD pixel information for a second color channel; aligning the first focus map to the reference focus map to detect a misalignment between the reference focus map and the first focus map; determining a magnitude of the misalignment; and applying chromatic aberration correction to the image information based on the detected misalignment and the magnitude of the misalignment.
Aspect 13. The method of Aspect 12, wherein applying the chromatic aberration correction comprises sharpening the second color channel based on the magnitude of the misalignment.
Aspect 14. The method of any of Aspects 12-13, further comprising generating a shift map based on an alignment between pixels of the first focus map and the reference focus map.
Aspect 15. The method of Aspect 14, wherein applying the chromatic aberration correction comprises warping the second color channel based on the shift map.
Aspect 16. The method of Aspect 15, further comprising warping the second color channel on a per pixel basis.
Aspect 17. The method of any of Aspects 12-16, further comprising generating focus maps based on a difference in light intensity between two or more photodiodes of one or more focus pixels.
Aspect 18. The method of any of Aspects 12-17, further comprising aligning the first focus map to the reference focus map based on a focused area.
Aspect 19. The method of any of Aspects 12-18, wherein the first color channel comprises a color channel used for focusing.
Aspect 20. The method of Aspect 19, wherein the first color channel comprises a green color channel.
Aspect 21. The method of any of Aspects 12-20, wherein the second color channel comprises one or a red or blue color channel.
Aspect 22. A non-transitory computer-readable medium having stored thereon instructions that, when executed by at least one processor, cause the at least one processor to: obtain image information from an image sensor including an array of pixels, the array of pixels including focus pixels; obtain phase detection (PD) pixel information from the focus pixels of the image sensor; generate a reference focus map based on PD pixel information for a first color channel; generate a first focus map based on PD pixel information for a second color channel; align the first focus map to the reference focus map to detect a misalignment between the reference focus map and the first focus map; determine a magnitude of the misalignment; and apply chromatic aberration correction to the image information based on the detected misalignment and the magnitude of the misalignment.
Aspect 23. The non-transitory computer-readable medium of Aspect 22, wherein, to apply the chromatic aberration correction, the instructions cause the at least one processor to sharpen the second color channel based on the magnitude of the misalignment.
Aspect 24. The non-transitory computer-readable medium of any of Aspects 22-23, wherein the instructions cause the at least one processor to generate a shift map based on an alignment between pixels of the first focus map and the reference focus map.
Aspect 25. The non-transitory computer-readable medium of Aspect 24, wherein, to apply the chromatic aberration correction, the instructions cause the at least one processor to warp the second color channel based on the shift map.
Aspect 26. The non-transitory computer-readable medium of Aspect 25, wherein the instructions cause the at least one processor to warp the second color channel on a per pixel basis.
Aspect 27. The non-transitory computer-readable medium of any of Aspects 22-26, wherein the instructions cause the at least one processor to generate focus maps based on a difference in light intensity between two or more photodiodes of one or more focus pixels.
Aspect 28. The non-transitory computer-readable medium of any of Aspects 22-27, wherein the instructions cause the at least one processor configured to align the first focus map to the reference focus map based on a focused area.
Aspect 29. The non-transitory computer-readable medium of any of Aspects 22-28, wherein the first color channel comprises a color channel used for focusing.
Aspect 30. The non-transitory computer-readable medium of Aspect 29, wherein the first color channel comprises a green color channel.
Aspect 31. The non-transitory computer-readable medium of any of Aspects 22-30, wherein the second color channel comprises one or a red or blue color channel.
Aspect 32: An apparatus for image correction, comprising one or more means for performing any of the operations of Aspects 12 to 21.

What is claimed is:

1. An apparatus, comprising:
at least one memory; and
at least one processor coupled to the at least one memory, the at least one processor configured to:
obtain image information from an image sensor including an array of pixels, the array of pixels including focus pixels;
obtain phase detection (PD) pixel information from the focus pixels of the image sensor;
generate a reference focus map based on PD pixel information for a first color channel;
generate a first focus map based on PD pixel information for a second color channel;
align the first focus map to the reference focus map to detect a misalignment between the reference focus map and the first focus map;
determine a magnitude of the misalignment; and
apply chromatic aberration correction to the image information based on the detected misalignment and the magnitude of the misalignment.

2. The apparatus of claim 1, wherein, to apply the chromatic aberration correction, the at least one processor is further configured to sharpen the second color channel based on the magnitude of the misalignment.

3. The apparatus of claim 1, wherein the at least one processor is further configured to generate a shift map based on an alignment between pixels of the first focus map and the reference focus map.

4. The apparatus of claim 3, wherein, to apply the chromatic aberration correction, the at least one processor is further configured to warp the second color channel based on the shift map.

5. The apparatus of claim 4, wherein the at least one processor is configured to warp the second color channel on a per pixel basis.

6. The apparatus of claim 1, wherein the at least one processor is further configured to generate focus maps based on a difference in light intensity between two or more photodiodes of one or more focus pixels.

7. The apparatus of claim 1, wherein the at least one processor is further configured to align the first focus map to the reference focus map based on a focused area.

8. The apparatus of claim 1, wherein the first color channel comprises a color channel used for focusing.

9. The apparatus of claim 8, wherein the first color channel comprises a green color channel.

10. The apparatus of claim 1, wherein the second color channel comprises one or a red or blue color channel.

11. The apparatus of claim 1, further comprising the image sensor.

12. A method for image correction, comprising:
obtaining image information from an image sensor including an array of pixels, the array of pixels including focus pixels;
obtaining phase detection (PD) pixel information from the focus pixels of the image sensor;
generating a reference focus map based on PD pixel information for a first color channel;
generating a first focus map based on PD pixel information for a second color channel;
aligning the first focus map to the reference focus map to detect a misalignment between the reference focus map and the first focus map;
determining a magnitude of the misalignment; and
applying chromatic aberration correction to the image information based on the detected misalignment and the magnitude of the misalignment.

13. The method of claim 12, wherein applying the chromatic aberration correction comprises sharpening the second color channel based on the magnitude of the misalignment.

14. The method of claim 12, further comprising generating a shift map based on an alignment between pixels of the first focus map and the reference focus map.

15. The method of claim 14, wherein applying the chromatic aberration correction comprises warping the second color channel based on the shift map.

16. The method of claim 15, further comprising warping the second color channel on a per pixel basis.

17. The method of claim 12, further comprising generating focus maps based on a difference in light intensity between two or more photodiodes of one or more focus pixels.

18. The method of claim 12, further comprising aligning the first focus map to the reference focus map based on a focused area.

19. The method of claim 12, wherein the first color channel comprises a color channel used for focusing.

20. The method of claim 19, wherein the first color channel comprises a green color channel, and wherein the second color channel comprises one or a red or blue color channel.
